(19) United States
(12) Patent Application Publication
(10) Pub. No.: US 2004/0253989 A1
(43) Pub. Date: Dec. 16, 2004

(54) Radio communication device having a navigational wheel

(76) Inventors: Amy M. Tupler, Hollywood, FL (US); Matthew R. Michieli, Gilbert, AZ (US); Robert P. Muszkiewicz, Scottsdale, AZ (US)

Correspondence Address: MOTOROLA, INC., 1303 EAST ALGONQUIN ROAD, IL01/3RD, SCHAUMBURG, IL, 60196

(21) Appl. No.: 10/460,493

(22) Filed: Jun. 12, 2003

(51) Int. Cl. H04B 1/38

(52) U.S. Cl. 455/566; 455/550.1

(57) ABSTRACT

A radio communication device (100) includes a navigational thumbwheel (102) that surrounds the periphery of the display area (114). Movement of the navigation thumbwheel (102) allows for movement of item(s) displayed on display area (114). The navigational thumbwheel (102) can be rotated either clockwise or counterclockwise. User controls (104) can be used to provide further movement/selection capabilities. In another embodiment, the navigational thumbwheel (102) can be depressed along certain portions of its outer ring (110), allowing the user further movement or selection capabilities using the thumbwheel (102).

### TECHNICAL FIELD

This invention relates in general to the field of electronics and more specifically, to a radio communication device having a navigational wheel.

### BACKGROUND

Designers of radio communication devices (e.g., cellular telephones, etc.) are always trying to find better ways to help navigate through the ever more complex graphical user interfaces being employed by newer radio communication devices. Some of the most popular navigational techniques currently being used for radio communication devices include the use of keys which allow a user to scroll through different menus, etc. Some electronic devices also have rotary wheels located on the device's housing that can be used to navigate and can also be used to select a chosen item since the wheel can also be depressed. All of the navigational techniques mentioned above suffer in that the navigational device is separate from the display area. Given the above, a need exists in the art for a navigational technique/device that can provide for improved navigation and provide a better user experience for radio communication device users.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a drawing of a radio communication device having a navigational wheel in accordance with an embodiment of the invention.

FIG. 2 shows an exploded view of the navigational wheel in accordance with an embodiment of the invention.

FIG. 3 shows the back of the navigational wheel and bezel shown in FIG. 2.

FIG. 4 shows a block diagram of a radio communication device in accordance with an embodiment of the invention.

FIG. 5 shows a flow chart highlighting the steps taken in accordance with an embodiment of the invention.

FIG. 6 shows a user using a navigational wheel in accordance with another embodiment of the invention.

FIG. 7 shows a navigational wheel and the underlying display in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

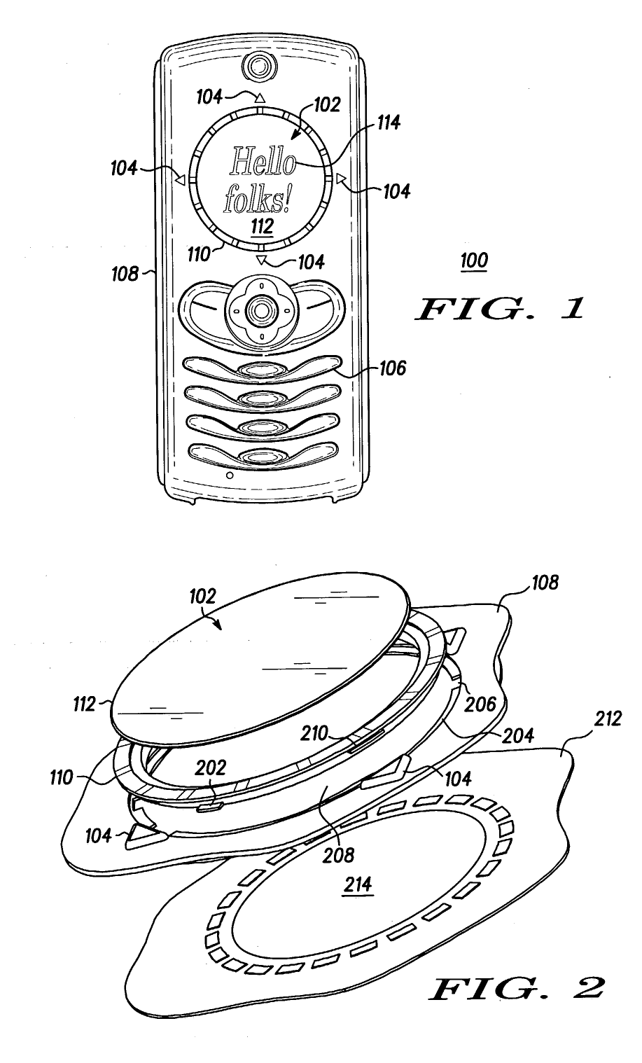

Referring now to FIG. 1, there is shown a radio communication device (e.g., cellular telephone, etc.) 100 in accordance with the invention. Radio 100 includes a navigational wheel (also referred to as a navigational thumbwheel) 102 that surrounds the display area 114 of the radio 100. Preferably, the navigational wheel 102 includes a clear or see-through bezel 112 and a surrounding ring 110 that can be rotated by the radio user. The rotation of ring 110 either clockwise or counterclockwise will be detected by the radio's electronics. Movement of what is being displayed, selection of menu items, and the like, will occur in response to the movement of the navigational wheel 102. Located in the radio housing 108 are a plurality of conventional keys 106 as are well known in the art that are used for alphanumeric entry and menu selection, to name a few. In accordance with one embodiment of the invention, a plurality of outer keys 104 surround the navigational wheel and are used to select items or move a cursor that is being displayed on the radio's display. Outer keys 104 used in conjunction with the navigational wheel 102 will allow for movement of items being displayed in a number of directions. Outer keys 104 in certain situations can also be used to scroll through different display items as well as can be used to select displayed items that are highlighted.

In FIG. 2, there is shown an exploded view of the navigational wheel 102.

Navigational wheel 102 includes a see-through bezel 112 and the outer ring 110. The outer ring 110 is wide enough for the user to rotate the navigational wheel either clockwise or counter-clockwise using his thumbs or fingers. The radio housing 108 has an aperture 208 which allows the radio's display 214 which is located on the radio's printed circuit board 212 to be seen through the bezel 112. Surrounding the aperture 208 is a groove 204 and a set of keyed areas 206 which match tabs 202 on the navigational wheel 102. Once the navigational wheel 102 is properly inserted into the radio's housing 108, the navigational wheel 102 can rotate freely in any direction and not fall off. An index 210 such as a conductive tab that can be detected (e.g., inductively, etc.) by the radio's electronics helps the radio's electronics determine whether the navigational wheel is being rotated clockwise or counterclockwise.

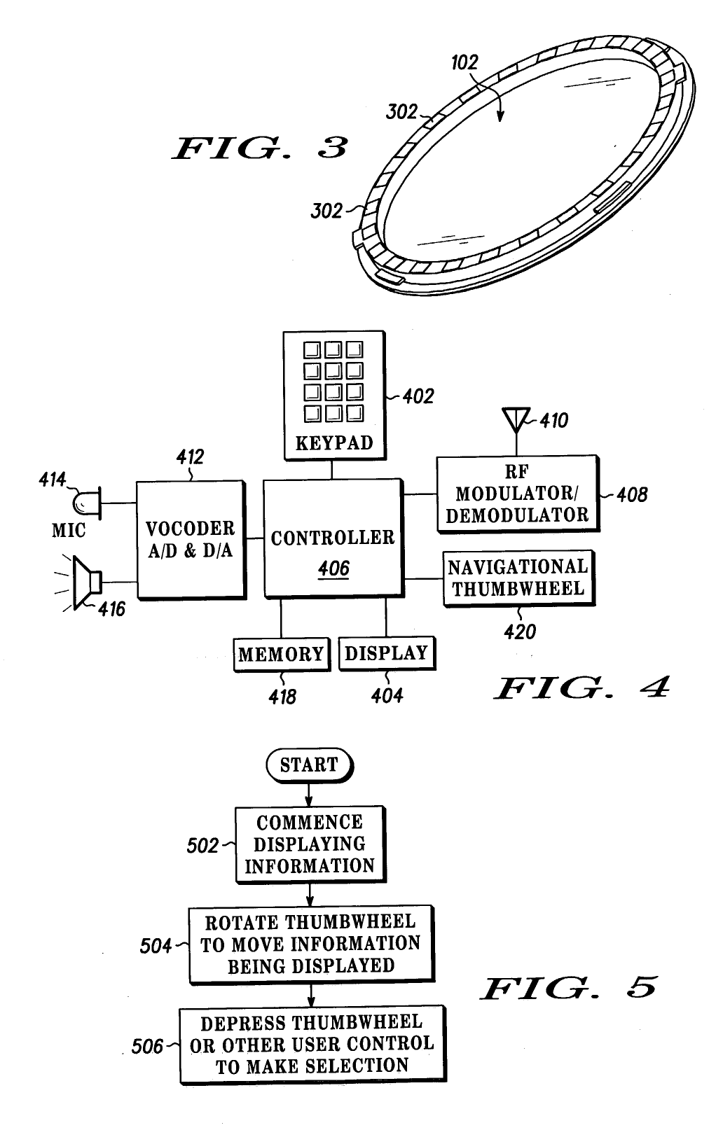

In FIG. 3, there is shown the back of the navigational wheel 102. Located on the back side of ring area 110 are a plurality of conductive contact pads 302 which are used by the radio electronics to determine the rotation of the wheel, using well known detection techniques. Pads 302 can be placed at ground potential and the detection technique employed can include inductive detection or other detection techniques as are well known in the art. In another embodiment of the invention, the navigational wheel can also be depressed along different portion of outer ring 110. The depression of the outer ring will cause an object displayed to move in the direction of the depression or be selected.

In FIG. 4, a block diagram of a radio communication device such as radio 100 is shown. The radio includes a controller 406 for controlling the overall operation of the radio. Radio Frequency (RF) signals are received and transmitted using antenna 410 which is connected to a conventional RF modulation and demodulator circuit 408. Coupled to the controller 406 is a memory section 418 which can include Random Access Memory (RAM) and Read Only Memory (ROM), flash memory, etc. A microphone 414 and speaker 416 are coupled via a conventional Vocoder and Analog-to-Digital (A/D) and Digital-to-Analog (D/A) circuit 412 which is used for processing the incoming and outgoing audio signals. A keypad 402 provides the radio user with the necessary user controls such as those used for entering alphanumeric messages, etc.

A display 404 which is surrounded by the navigational thumbwheel 420 is provided for displaying information to the radio user. Finally, the navigational thumbwheel circuit 420 includes the necessary hardware and software which allows for the use of the navigational thumbwheel in controlling the movement and/or selection of items being displayed on display 404.

Referring now to FIG. 5, there is shown a simplified flowchart highlighting the main steps in the use of the navigational thumbwheel. In step 502, the radio commences displaying information on display 404. In step 504, the radio user can then rotate the navigational thumbwheel to control the movement of information that is being displayed. For example, if a game is being presented on display 404, the movement of the navigational thumbwheel can cause movement of what is being displayed in the desired direction. When menu items are being displayed, the movement of the navigational wheel can cause a selection icon to move to the desired menu item. In step 506, a radio user can depress a user control such as buttons 104 (FIG. 1) to select the desired menu item. In another embodiment of the invention, the navigational wheel itself can also be depressed along certain points in order to provide a selection capability. In such a case, the navigational wheel has to be designed using conventional designs to allow it to be depressed inward along portions of the outer ring.

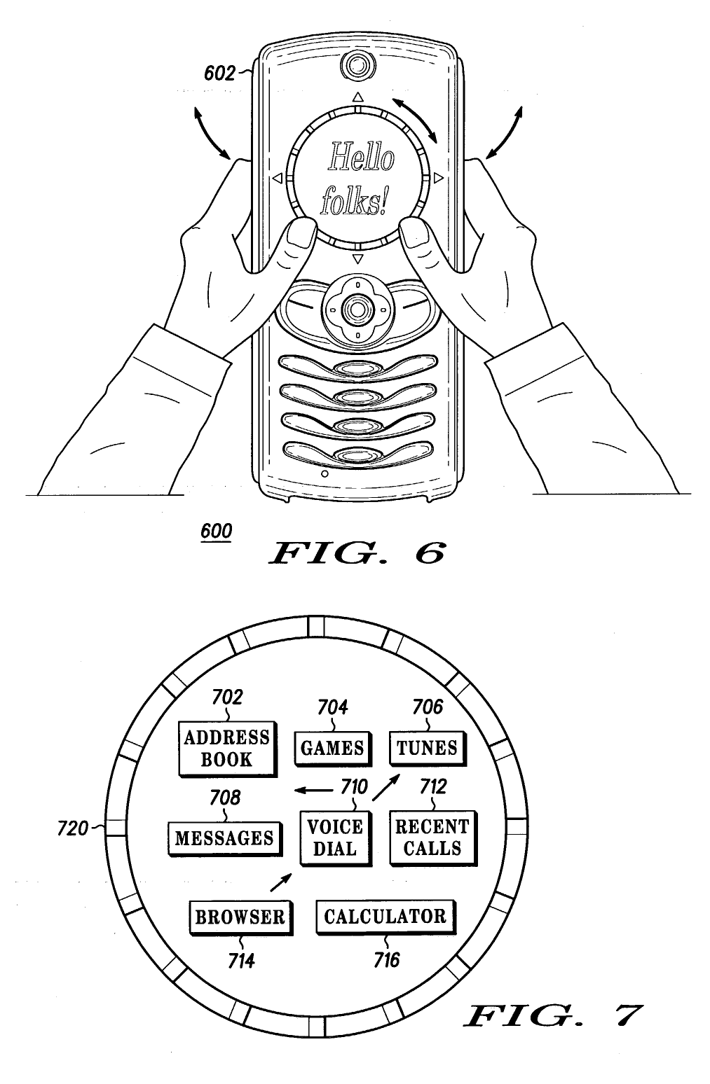

In FIG. 6, there is shown a radio user controlling a navigational thumbwheel 600 located on 602. The radio user in this scenario can move the navigational thumbwheel clockwise or counterclockwise as well as depress the thumbwheel to cause selection or further movement of any displayed items.

In FIG. 7, there is shown an illustrative example of a series of menu items 702-716 being displayed on a display surrounded by a navigation thumbwheel 720 in accordance with an embodiment of the present invention. One of the menu items 702-716 is typically highlighted and the movement of the navigational thumbwheel 720 causes a change in which menu 702-716 item is highlighted. For example, if the currently highlighted item is menu item “Browser” 714, rotation of the thumbwheel 720, can cause the movement of the highlighted menu item from one menu item to the next. Once the desired menu item is highlighted, activating a user control such as buttons 104 in FIG. 1 can cause the selection of the highlighted menu item.

Alternatively, in another navigational design, the user can use a combination of the thumbwheel and the user controls 104 to move to the desired menu item. For example, movement from menu item “Browser” 714 to menu item “Voice Dial” 710 could be accomplished by movement of the thumbwheel counterclockwise (although a clockwise movement can also allow a user to reach his desired item) so that the highlighted menu item goes from item 714 to item 716 then on to item 712, at which point pressing the left button 104 can cause the selected menu item to move to the desired menu item “Voice Dial” 710. Once the desired menu item is highlighted, pressing another user key, for example one of the keys 106 can cause the selection of the item. In another design of the thumbwheel, whereby the thumbwheel can not only be rotated in either direction but can also be depressed around different locations around its periphery, the movement from menu item 714 to menu item 710 can be realized by simply depressing the navigational thumbwheel 720 at about the 2 o'clock position. Activation of the selected menu item can then be done by pressing one of the user controls 104 or 106.

The use of a navigation thumbwheel that surrounds the radio communication device's display helps bring the user closer to the action, helping to link the visual and physical experiences together. In a gaming environment, the user would be able to “lean into” curves, etc. If a map is displayed for example, the user would be able to navigate as they might drive, turning the map north as they head north. Since the navigational thumbwheel surrounds the display area, the user does not have to move his eyes from the primary area of focus.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A radio communication device, comprising:
a display; and
a navigational wheel surrounding the display.

2. A radio communication device as defined in claim 1, wherein the navigational wheel can be rotated in order to one of move and select an item that is being displayed on the display.

3. A radio communication device as defined in claim 1, further comprising:
a plurality of user controls located around a periphery of the navigational wheel, the plurality of user controls allowing for one of movement and selection of an item being displayed on the display.

4. A radio communication device, as defined in claim 1, wherein the navigational wheel includes a see-through bezel and a ring surrounding the see-through bezel.

5. A radio communication device as defined in claim 4, wherein the see-though bezel is located substantially over the display, allowing for an item displayed in the display to be seen through the see-through bezel.

6. A radio communication device as defined in claim 4, wherein the ring is configured to allow for depression, thereby allowing for one of further movement of an item being displayed and selection of the item.

7. A method for controlling information on a radio communication device display, comprising the steps of:
displaying information on the display; and
rotating a navigational wheel that surrounds the display in order to control the information being displayed.

8. A method as defined in claim 7, wherein the step of rotating comprises
rotating the navigational wheel in one of a clockwise and counterclockwise direction.

9. A method as defined in claim 7, further comprising the step of:
depressing the navigational wheel in order to one of move and select the information being displayed.

10. A method as defined in claim 7, wherein the navigational wheel comprises a see-through bezel and a ring surrounding the see-through bezel.
